(19) United States
(12) Patent Application Publication
(10) Pub. No.: US 2020/0086235 A1
(43) Pub. Date: Mar. 19, 2020

(54) APPARATUS AND METHODS FOR FILTERING/COALESCING GAS

(71) Applicant: JXP SYSTEMS, LP, HOUSTON, TX (US)

(72) Inventor: VAN BARCLAY, HOUSTON, TX (US)

(21) Appl. No.: 16/134,977

(22) Filed: Sep. 19, 2018

(51) Int. Cl. B01D 17/04; B01D 35/30; B01D 36/00

(52) U.S. Cl. CPC B01D 17/045; B01D 36/001; B01D 36/003; B01D 35/30

(57) ABSTRACT

Methods, apparatus and products for filtering, utilizing a filter system having a filter element coupled with a coalescer element and an intermediate element interposed between the filter and coalescer elements, wherein the intermediate element serves to improve function of the filter system by shifting the flow pattern between the filter and coalescer elements and/or precondition the droplets for the coalescer.

### RELATED APPLICATION DATA

Not applicable.

### BACKGROUND OF THE INVENTION

### 1. Field of the Invention

The present invention relates to methods, apparatus and products for filtering. In another aspect, the present invention relates to methods, apparatus and products for filtering streams of gas and/or liquids to remove solids and/or entrained liquids. In even another aspect, the present invention relates to methods, apparatus and products for filtering, utilizing a filter system having a filter element coupled with a coalescer element and an intermediate element interposed between the filter and coalescer elements. The filter element may also provide initial coalescing so that the intermediate agglomerator is more effective. In still another aspect, the present invention relates to methods, apparatus and products for filtering, utilizing a filter system having a filter element coupled with a coalescer element and an intermediate element interposed between the filter and coalescer elements, wherein the intermediate element serves to improve function of the filter system by shifting the flow pattern between the filter and coalescer elements and/or precondition the droplets for the coalescer.

### 2. Description of the Related Art

There are a number of patents that relate to removing solids and/or liquids from gas streams, the follow of which are merely a small sampling.

U.S. Pat. No. 6,381,983, issued May 7, 2002, to Angelo et al., discloses an improved filter drier for a refrigeration system having a replaceable tubular filter element. A desiccant assembly is removably secured within a housing. The assembly includes a first and second molded desiccant, a hollow tubular perforated core located within said first and second molded desiccant, and a tubular filter located over said core.

U.S. Pat. No. 6,692,639, issued Feb. 17, 2004, to Spearman et al., discloses a conically shaped filtration and/or separation apparatus that is constructed from a stack of filters at least some of which are different sizes superposed above each, other, of said plurality of said filters in a fluid communicable relationship. A collapsible version of such conically shaped filter and/or separation apparatus is provided whereby a plurality of such filters are connected together using two piece interlocking or connecting end caps.

U.S. Pat. No. 6,858,067, issued Feb. 22, 2005, to Bums et al., discloses a filtration vessel for use with a rotary screw compressor that receives a compressed liquid/gas mixture from the compressor. The vessel utilizes a first stage vortex knockout region to remove bulk liquids through a circular motion that imposes centrifugal forces on the gas and liquid mixture. A coalescer region located above the vortex knockout region receives the relatively lighter fluids and separates any remaining entrained liquids from the fluids. The discharge from the filtration unit is an essentially liquid free compressed gas. The liquid discharge, in the case of lube oil can be recirculated to the compressor for another cycle.

U.S. Pat. No. 7,051,540, issued May 30, 2006, to TeGrotenhuis et al., discloses a wick-containing apparatus capable of separating fluids and methods of separating fluids, and somewhat technologically different than the other patents listed herein.

U.S. Patent Application Publication No. 20070095746, published May 3, 2007 to Minichello et al., discloses an apparatus for filtering a gas or liquid stream such as a natural gas stream. The apparatus includes a closed vessel having a longitudinally extending length, an initially open interior, an inlet port at one extent and an outlet port at an opposite extent thereof. A partition located within the vessel interior divides the vessel interior into a first chamber and a second chamber. At least one opening is provided in the partition. A filter element is disposed within the vessel to extend from within the first chamber. A special seal structure formed of a resilient material and having conically shaped sidewalls is used to seal against one end of the filter element as well as forming a dynamic seal with the vessel riser in use.

U.S. Pat. No. 7,270,690, issued Sep. 18, 2007, to Sindel, discloses a separator vane assembly made up of a number of corrugated vanes that provide serpentine paths for the gas stream therethrough. As the gas stream flows through the serpentine paths, it changes direction and liquid in the gas stream impacts the surfaces of the vanes. The upstream section of the vane assembly has roughened surfaces to decrease the surface tension of the liquid, thereby causing the liquid to coalesce. The downstream section of the vane assembly has smooth surfaces so as to increase the surface tension of the liquid. The vane assembly is followed by filters, which capture the liquid that passes through the vane assembly. The vane assembly coalesces the liquid to enable the filters to operate more effectively.

U.S. Patent Application Publication No. 20070251876, published Nov. 1, 2007 to Krogue et al., discloses an apparatus for filtering a gas or liquid stream of impurities and to filter elements used in such an apparatus. The apparatus includes a closed vessel having a longitudinally extending length, an initially open interior, an input port at one extent and an output port at an opposite extent thereof. A partition located within the vessel interior divides the vessel interior into a first stage and a second stage. At least one opening is provided in the partition. A filter element is disposed within the vessel to extend from within the first stage. The filter element is made up of a carbon block filter media surrounded by a protective porous depth filter media.

U.S. Pat. No. 7,314,508, issued Jan. 1, 2008, to Evans, discloses a desiccant cartridge having a seal therearound for forming a proper seal between the cartridge and the canister of a receiver/dryer or accumulator assembly includes a cup extending along an axis having inner wall portion and outer wall portion connected to a transverse portion to define a chamber containing desiccant particles. A cap is secured to cup to secure the desiccant particles inside the chamber. The outer wall portion is provided with the seal that is composed of a flexible thermoplastic elastomer that is resistant to heat during welding shut of the canister. Desiccant technologies generally provide higher efficiency as compared to filter/coalescer/separator technologies, but are sacrificial (the desiccant is “used up” when it cleans). In contrast, coalescer technologies are continuous, but provide lower efficiency.

U.S. Pat. No. 7,332,010, issued Feb. 19, 2008, to Steiner, discloses a two or three phase separator including a centrifugal separator, a demister (if a three phase separator), and a filter contained within a housing. The filter uses an outside-in flow principle. The filter includes an inner layer or a center core that defines a hollow interior. An outer layer is positioned adjacent and surrounding the inner layer. The outer layer includes a re-enforcement layer, a first particle filter layer, a coalescer layer, and a second particle filter layer. An access cover of the separator includes a cover plug, an actuator cam, a plurality of idler cam plates, and a plurality of mechanisms. The access cover cooperates with an opening and an annular groove in the housing to close off and seal the separator. This Steiner separator provides bulk knockout, then medium removal, and then fine coalescing. In some embodiments of the present invention the fines are removed first, then the rest of the vessel technology is used to grow and separate the more difficult liquids side.

U.S. Pat. No. 7,344,576, issued Mar. 18, 2008, to TeGrotenhuis et al., is a membrane related technology that discloses methods of separating fluids using capillary forces and/or improved conditions. The improved methods may include control of the ratio of gas and liquid Reynolds numbers relative to the Suratman number. Also disclosed are wick-containing, laminated devices that are capable of separating fluids.

Quite commonly in pipeline applications, it is not uncommon to see multi-stage vessels, as well as a multitude of other similar filtration vessels, that utilize solid or hollow core tubular elements, typically formed at least partially a porous filtration media. Non-limiting examples of such vessels include filtration equipment such as shown in U.S. Pat. No. 5,919,284, issued Jul. 6, 1999 or U.S. Pat. No. 6,168,647, issued Jan. 2, 2001, both to Perry, Jr. et al.

U.S. Pat. No. 5,919,284 discloses a gas filter separator coalescer and multi-stage vessel for separating liquids and solids from a gas stream and simultaneously coalescing liquids from the gas stream. The apparatus includes a closed vessel having a longitudinally extending length, an initially open interior, an input port at an extent and an output port at an opposite extent thereof. There is a partition located within the vessel interior that divides the vessel interior into a first stage and a second stage. There is at least one opening in the partition. A separator/coalescer filter element is disposed within the vessel to sealingly extend from within the first stage through the opening into the second stage. There is a chevron-type seal or an O-ring seal between the filter element and the opening. The input port, vessel interior, separator/coalescer filter element and output port together define a flow passage within the apparatus, whereby the gas stream flows into the first stage through the input port and through the filter element hollow core, thereby filtering solids out of the gas stream, separating liquids from the gas stream, and pre-coalescing liquids in the gas stream. The gas stream then flows along the hollow core past the partition and back through the filter element into the second stage, thereby coalescing liquids out of the gas stream, the gas stream then exiting the second stage through the outlet port.

U.S. Pat. No. 6,168,647 discloses an apparatus for separating liquids and solids from a gas stream and simultaneously coalescing liquids from the gas stream. The apparatus includes a closed vessel having a longitudinally extending length, an initially open interior, an input port at an extent and an output port at an opposite extent thereof. There is a partition located within the vessel interior that divides the vessel interior into a first stage and a second stage. There is at least one opening in the partition. A separator/coalescer filter element is disposed within the vessel to sealingly extend from within the first stage through the opening into the second stage. There is a chevron-type seal or an O-ring seal between the filter element and the opening. The input port, vessel interior, separator/coalescer filter element and output port together define a flow passage within the apparatus, whereby the gas stream flows into the first stage through the input port and through the filter element hollow core, thereby filtering solids out of the gas stream, separating liquids from the gas stream, and pre-coalescing liquids in the gas stream. The gas stream then flows along the hollow core past the partition and back through the filter element into the second stage through a louvered impingement baffle, thereby coalescing liquids out of the gas stream, the gas stream then exiting the second stage through the outlet port. The louvered impingement baffle conditions the gas stream to create a scrubbing effect on any fine mist exiting the separator/coalescer filter element.

With such equipment as disclosed in the U.S. Pat. No. 5,919,284 or 6,168,647, it is periodically necessary to perform maintenance on the filtration vessels, including replacement of the porous filter elements. This task is labor intensive and time consuming insitu because of the mounting structure used to mount the filter elements within the filtration vessel interior. Often, it is necessary to unscrew the end cap or nut to free the filter element from its associated structural mounting within the vessel interior. Not only is this time consuming, but the location of the mounting structure is sometimes inconvenient to access, making filter replacement a difficult or inconvenient chore. The same type of inconveniences is present in the initial filter installation process for new filtration vessels.

Specifically for filter systems of the type disclosed in U.S. Pat. No. 6,168,647, there are at least two reasons for the difficulty in removing the filter elements. First, the chevron seal is working against the removal direction when trying to remove the element. Second, since the filter element extends into the riser assembly, solids collect and pack into the riser assembly. Additionally, it is not uncommon to find damage to the downstream expanded metal support grid generally caused by the elements being shoved in too far.

In an effort to overcome the problems of the prior art, especially the deficiencies of U.S. Pat. No. 5,919,284 or 6,168,647, further development was advanced in U.S. Pat. No. 7,014,685, issued Mar. 21, 2006, and U.S. Pat. No. 7,108,738, issued Sep. 19, 2006, both to Bums et al. These two patents disclose an apparatus for filtering a gas or liquid stream such as a natural gas stream. The apparatus includes a closed vessel having a longitudinally extending length, an initially open interior, an input port at one extent and an output port at an opposite extent thereof. A partition located within the vessel interior divides the vessel interior into a first stage and a second stage. At least one opening is provided in the partition. A filter element is disposed within the vessel to extend from within the first stage. The filter element is easily mounted or removed from the vessel by rotating a J-slot engagement surface on the element which mates with a post provided on a mounting structure provided on the vessel partition.

However, in spite of the above advancements that have been made in overall filtration vessel design, there still exists a need in art for apparatus and methods for filtration.

There also exists a need in the art for apparatus and methods for improvements that simplify the process of mounting and replacing filter elements within the filtration vessel, thereby decreasing the cost of vessel installation and maintenance.

As a non-limiting example of a desired improvement, for filtration systems as disclosed in U.S. Pat. Nos. 5,919,284, and 6,187,647, the portion of the filter element positioned in the downstream stage is generally a lot cleaner than the portion of the filter element positioned in the upstream stage. However, with these filtration systems, the entire filter element is removed and replaced, even though the downstream portion of the filter may be readily further used.

There have been a number of advances by Clark et al. as follows:

U.S. Patent Publication No. 20100224065, published Sep. 9, 2009, by Clarke et al, discloses device for filtering a gas stream, having a vessel partitioned into a first stage and a second stage, with an opening between stages. A filter element is positioned in the opening, with ends of the filter element extending into the first and second stages. The first member is removable from the second member while the filter element is positioned in the opening, to allow for replacement with a new clean member.

U.S. Patent Publication No. 20140165516, published Jun. 19, 2014, by Clarke et al., provides a filter system an end cap engaging and covering the opening, having an annular shaped sealing edge engaging the sealing lip, and having a parallel sided cylindrical guide portion positioned within the opening, and having an elongated cavity portion having a non-threaded first portion and a threaded second portion.

U.S. Pat. No. 9,566,543, issued Feb. 14, 2017, is a continuation-in-part of U.S. Patent Publication No. 20100224065, disclosing a riser member having a first end with a straight portion and a second end with a flared portion.

However, in spite of the above advancements that have been made in overall filtration vessel design, there exists a need in art for apparatus and methods for filtration.

The inventors have determined that the above filter systems utilizing a filter element in combination with a coalescer element, could be improved by incorporation of a intermediate element that serves to improve function of the filter system by shifting the flow pattern between the filter and coalescer elements and/or precondition the droplets for the coalescer.

There exists another need in the art for a filter system utilizing a filter element in combination with a coalescer element, with an intermediate element between the filter and coalescer elements.

There exists even another need in the art for a filter system utilizing a filter element in combination with a coalescer element, with an intermediate element that serves to improve function of the filter system by shifting the flow pattern between the filter and coalescer elements.

There exists still another need in the art for a filter system utilizing a filter element in combination with a coalescer element, could be improved by incorporation of a intermediate element that serves to precondition the droplets for the coalescer.

There exists yet another need in the art for a filter system utilizing a filter element in combination with a coalescer element, could be improved by incorporation of a intermediate element that serves to improve function of the filter system by shifting the flow pattern between the filter and coalescer elements and/or precondition the droplets for the coalescer.

There exists even still another need in the art to customize the filtration, agglomeration, coalescence and/or separation. With fewer solids, the initial filter can do more coalescing, and with dirtier service, primary filtration can be handled with the front side of the filter and coalescence and separation on the back side of the filter.

There exists even yet another need in the art for a filter system that provides the ability to shift forward and backward without changing the vessel.

There exists still even another need in the art for a vessel that can be used for gas conditioning, the same setup can be used for liquid/liquid separation as well.

These and other needs in the art will become apparent to those of skill in the art upon review of this specification, including its drawings and claims.

### BRIEF SUMMARY OF THE INVENTION

It is an object of the present invention to provide for apparatus and methods for filtration.

It is another object of the present invention to provide for a filter system utilizing a filter element in combination with a coalescer element, with an intermediate element between the filter and coalescer elements.

It is another object of the present invention to provide for a filter system utilizing a filter element in combination with a coalescer element, with an intermediate element that serves to improve function of the filter system by shifting the flow pattern between the filter and coalescer elements.

It is another object of the present invention to provide for a filter system utilizing a filter element in combination with a coalescer element, could be improved by incorporation of a intermediate element that serves to precondition the droplets for the coalescer.

It is another object of the present invention to provide for a filter system utilizing a filter element in combination with a coalescer element, could be improved by incorporation of a intermediate element that serves to improve function of the filter system by shifting the flow pattern between the filter and coalescer elements and/or precondition the droplets for the coalescer.

It is another object of the present invention to provide for customizing the filtration, agglomeration, coalescence and/or separation. With fewer solids, the initial filter can do more coalescing, and with dirtier service, primary filtration can be handled with the front side of the filter and coalescence and separation on the back side of the filter.

It is another object of the present invention to provide for a filter system that provides the ability to shift forward and backward without changing the vessel.

It is another object of the present invention to provide for a vessel that can be used for gas conditioning, and the same setup can be used for liquid/liquid separation as well.

These and other objects of the present invention will become apparent to those of skill in the art upon review of this specification, including its drawings and claims

According to one non-limiting embodiment of the present invention there is provided a replaceable cartridge for use in a vessel for processing a flowing gas stream comprising droplets. The cartridge may include a first stage member comprising a filer element and a second stage member comprising a coalescer element. The cartridge may also include an intermediate stage member interposed between the first and second stages, said intermediate stage comprising structure to alter the flowing gas stream as it flows between the first and second stages and pre-condition the droplets, said structure selected from the group of structures consisting of baffles, spargers, in-line mixers, spiral shaped baffles, wire mesh, vaned members, slotted members, and protrusions. In certain non-limiting sub-embodiments, the intermediate stage comprises baffles; the intermediate stage comprises spiral baffles sufficient to impart rotation to the flowing gas stream, or the intermediate stage comprises mesh.

According to another non-limiting embodiment of the present invention there is provided a method of processing a flowing gas stream comprising droplets. The method may include filtering the gas stream in a first stage filter element to produce a filtered gas stream. The method may include altering the filtered gas stream in an intermediate stage to alter the flow pattern of the filtered gas stream and pre-condition the droplets to produce an altered-flow gas stream. The method may include coalescing the altered-flow gas stream in a second stage coalescer to produce processed gas. In certain non-limiting sub-embodiments: the altering step comprises passing the filtered gas stream past a spiral vane to rotate the filtered gas stream.

According to even another non-limiting embodiment of the present invention there is provided an apparatus for separating liquids and solids from a gas stream and simultaneously coalescing liquids from the gas stream. The apparatus may include a closed vessel having a longitudinally extending length, an initially open interior, an input port at an extent and an output port at an opposite extent thereof. The apparatus may also include a partition located within the vessel interior, the partition dividing the vessel interior into a first stage and a second stage, with at least one opening in the partition. The apparatus may also include a separator/coalescer filter element disposed within the vessel to sealingly extend from within the first stage through the opening into the second stage, with the filter element defining a hollow core and comprising an intermediate device positioned within the hollow core and comprising structure selected from the group of structures consisting of baffles, spargers, in-line mixers, spiral shaped baffles, wire mesh, vaned members, slotted members, and protrusions. In this apparatus, the input port, vessel interior, separator/coalescer filter element and output port together defining a flow passage within the apparatus, whereby the gas stream flows into the first stage through the input port and through the filter element hollow core thereby filtering solids out of the gas stream, separating liquids from the gas stream, and pre-coalescing liquids in the gas stream, and wherein the gas stream then flows through the intermediate device altering the flow pattern of the gas stream and pre-conditioning the liquids, and wherein the gas stream then flows along the hollow core past the partition and back through the filter element into the second stage, thereby coalescing liquids out of the gas stream, the gas stream then exiting the second stage through the outlet port. In certain non-limiting sub-embodiments, the intermediate stage comprises baffles; the intermediate stage comprises spiral baffles sufficient to impart rotation to the flowing gas stream; and the intermediate stage comprises mesh.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 and FIG. 2 show two views of existing filter-separator technology, with Filter-Separator 100 including outlet 101, inlet 103, element stage 104, knockout stage 107, secondary liquid pump 110, and primary liquid pump 111.

FIG. 3 shows the Jonell Twist Lok™ system 200 including a first stage filter element 201, a second stage coalescer element 202, and a locking system 205 comprising a first locking member 206 on first stage 201 and a second locking member 207 on second stage 202, with locking members 206 and 207 being operable to lock together stages 201 and 202, and being operable to unlock and allow separation of stages 201 and 202.

FIG. 4 shows one non-limiting embodiment 300 of the present invention, showing first stage filter element 301, second stage coalescer element 302, and intermediate device 325.

FIGS. 5-7, there are shown, respectively, a picture, drawing and schematic of one embodiment of intermediate device 325, namely, an example of a cyclonic embodiment of intermediate device 325.

FIGS. 8-10, show other non-limiting cyclonic embodiments of intermediate element 325, which may be axial cyclonic with a center body, can be an angled vane type, or may be a milled slot type.

### DETAILED DESCRIPTION OF THE INVENTION

The present invention is easily understood in terms of the prior art technology.

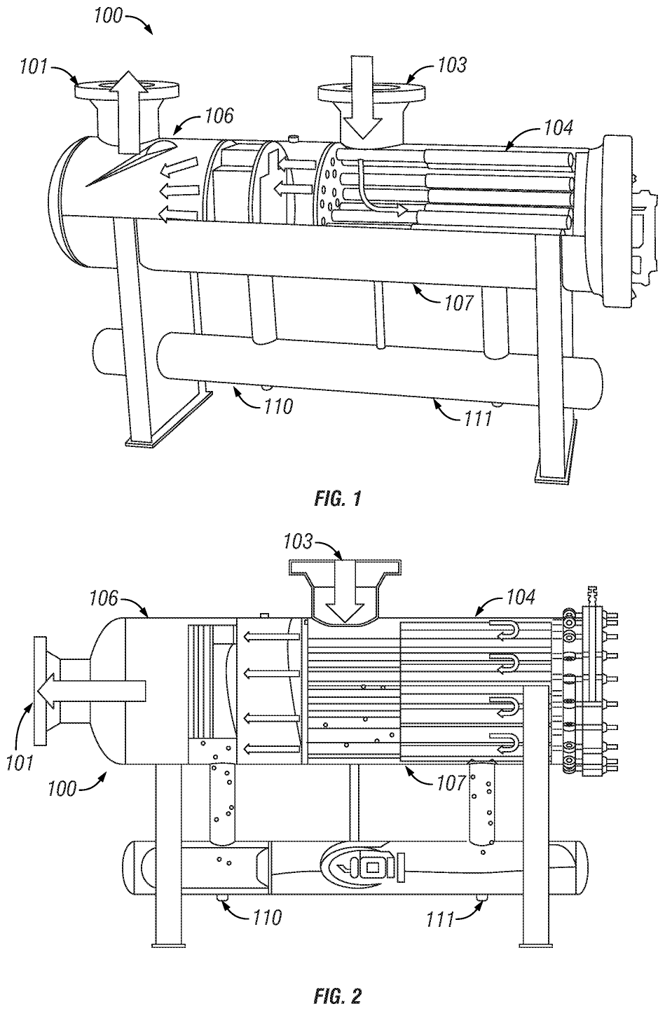

Referring now to FIG. 1 and FIG. 2, there are shown two views of existing filter-separator technology. Filter-Separator 100 includes outlet 101, inlet 103, element stage 104, knockout stage 107, secondary liquid pump 110, and primary liquid pump 111. Basically, this type of filter-separator operates with the flow path being outside to in on the elements. There is a second mechanical stage for liquids removal. Benefits of this type of filter-separator include that it is well understood technology, and it provides good contaminant handling ability. However, drawbacks include that this type of filter-separator is generally only functional to about 1 micron, and that it is expensive to fabricate.

Further existing technology is provided in U.S. Pat. Nos. 5,919,284 and 6,168,647, both described above. The apparatus can be described as a single element divided by a tubesheet. The first stage flows outside to inside, the second stage flows inside to outside, with 0.3 efficiency obtainable.

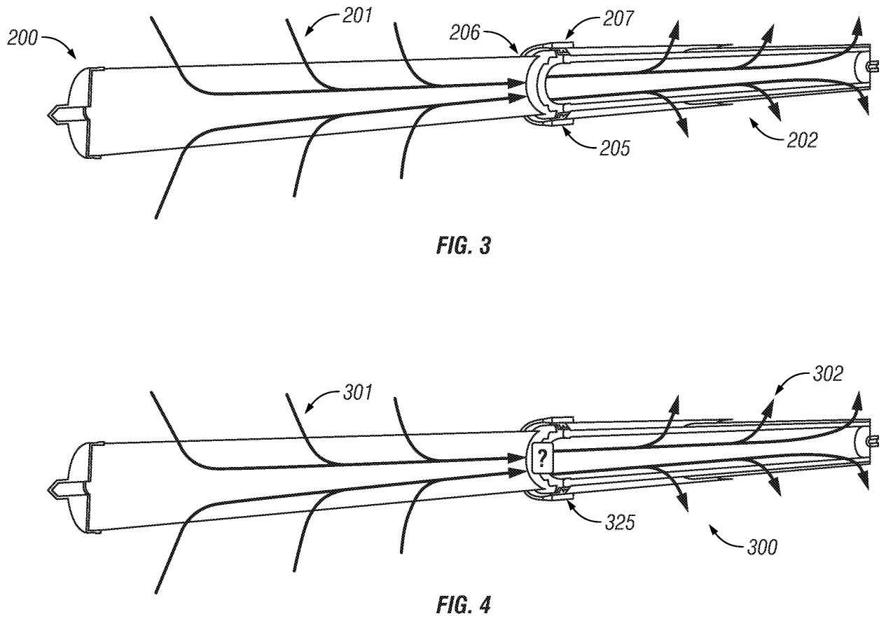

Referring further to FIG. 3, there is shown the Jonell™ Twist Lok™ system 200 including a first stage filter element 201, a second stage coalescer element 202, and a locking system 205 comprising a first locking member 206 on first stage 201, and a second locking member 207 on second stage 202, with locking members 206 and 207 being operable to lock together stages 201 and 202, and being operable to unlock and allow separation of stages 201 and 202.

Like the apparatus described in the '284 and the '647 patents above, the flow through the system is outside to in for the first stage and inside to out for the second stage. This system includes a first stage filter element and a second stage coalesce. In operation of the '284 and '647 patent apparatus, it is commonly true that the second stage element does not always need to be replaced. As an advantage, the Twist Lok™ system provides filter and coalescer elements that are locked together but unlockable, allowing for replacement of the first stage filter element without having to replace the second stage coalescer element. Further, both the first stage and second stage can be easily optimized independently for cost and performance.

In one aspect, the present invention provides a filtration filter/coalescer. In another aspect, the present invention provides a filtration system that includes the filtration filter/coalescer positioned within a filtration vessel. In even other aspects, the present invention provides methods of processing gas, methods of filtering/coalescing, and methods of making and using such filtration filter/coalesers and filtration systems. The filtration filter of the present invention may include a single member that includes the filter element and the coalescer element, or may include a first member filter element and a second member coalescer element that are removably attached to each other. The filter system of the present invention will include an intermediate element positioned between the filter element and the coalescer element, which intermediate element may be incorporated into the single member, the first member, the second member, both the first and second members, or into its own third member.

The filtration filter of the present invention includes an intermediate element interposed between the filter and coalescer elements, wherein the intermediate element serves to improve function of the filter system by shifting the flow pattern between the filter and coalescer elements and/or precondition the droplets for the coalescer. The filter element may also provide initial coalescing so that the intermediate agglomerator is more effective.

The idea of the intermediate element is to modify the flow pattern between the filter and coalescer element. Generally, this intermediate element will comprise any sort of structure that will modify the flow pattern between the filter element and the coalescer element and/or precondition the droplets for the coalescer. Examples of suitable structures include baffles, spargers, in-line mixers, spiral shaped baffles, wire mesh, vaned members, slotted members, protrusions, and/or members with a roughened surface.

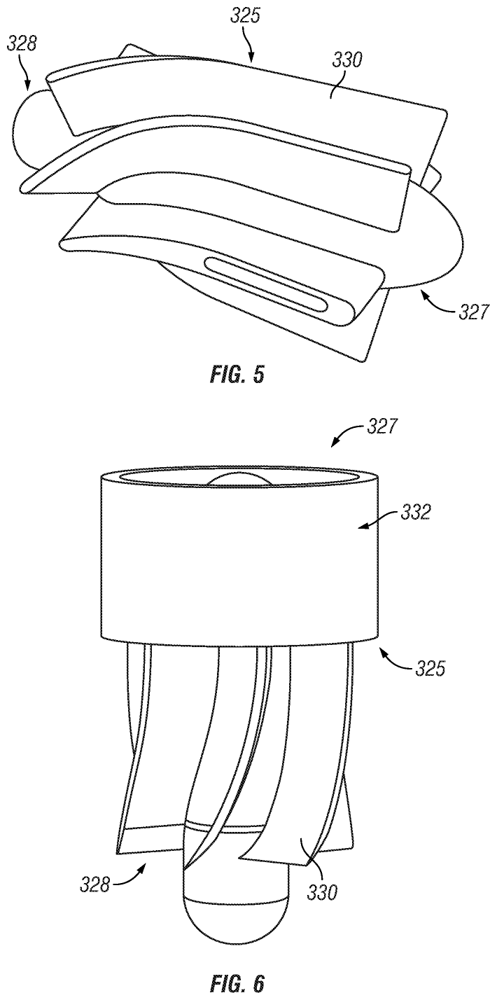

Referring now to FIG. 4, there is shown one non-limiting embodiment 300 of the present invention, showing first stage filter element 301, second stage coalescer element 302, and intermediate device 325. It is believed that this intermediate device 325 improves function of filter-coalescer systems by altering the gas flow between the first stage and second stage, and/or pre-conditioning the droplets for the coalescer. This altering may include, shifting, changing, disrupting, disturbing, re-routing, reshaping, refashioning, transforming and/or modifying In certain non-limiting embodiments of the present invention, intermediate device 325 will impart rotation to the gas flow, clockwise in some embodiments, counter-clockwise in other embodiments.

It should be understood that interposed between the first and second stage elements 301 and 302 could be intermediate device 325, and there may or may be any locking system between the stages. That is, this intermediate device is believed to be useful when incorporated into the apparatus of U.S. Pat. Nos. 5,919,284 and 6,168,647 and any other similar two stage filter-coalescer systems with permanently attached filter and coalescer stages, and is also believed to be useful when incorporated into the Jonell™ Twist Lok™ system and any other similar filter-coalescer systems with lockable/unlockable filter and coalescer stages. Thus, various system embodiments of the present invention include systems in which the intermediate device of the present invention is incorporated into, integrated into, combined with or otherwise utilized with the apparatus of U.S. Pat. Nos. 5,919,284 and 6,168,647, the Jonell™ Twist Lok™ system, and/or any other two stage filter-coalescer systems.

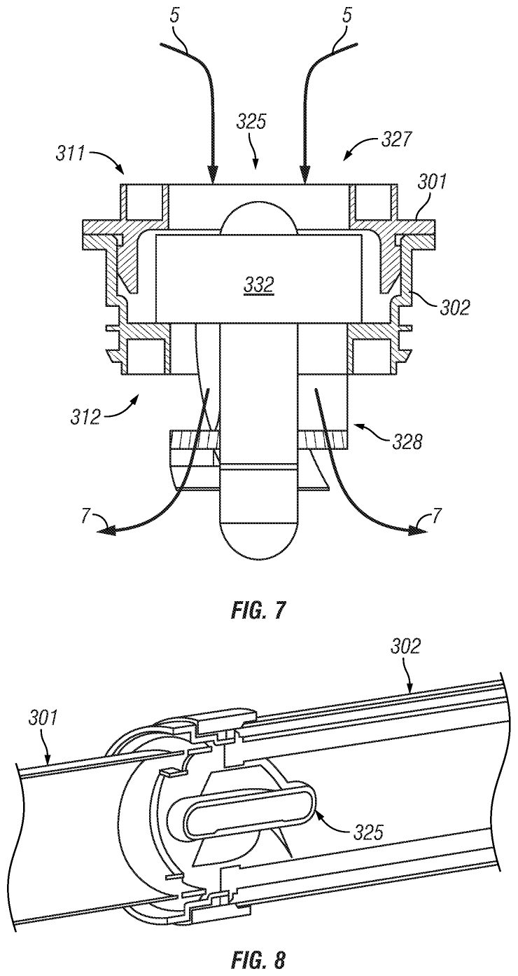

Referring now to FIGS. 5-7, there are shown, respectively, a picture, drawing and schematic of one embodiment of intermediate device 325, namely, an example of a cyclonic embodiment of intermediate device 325.

This intermediate device 325 further includes inlet 327 for receiving gas flow 5 from first stage filter 301, outlet 328 for discharge of exit gas 7. Intermediate device 325 may improve function of filter/coalescer systems by changing the gas flow-pattern and/or pre-conditioning droplets for the coalescer. This non-limiting cyclonic embodiment further includes one or more spirally shaped vanes 330 to impart rotation or circulation of the gas flow, which is counter-clockwise in the non-limiting embodiment as shown. However, it should be understood that intermediate device 325 could impart to the gas either clockwise (FIGS. 6 and 7) or counter-clockwise (FIG. 5) rotation as may be desired. It should also be understood that other non-limiting embodiments of intermediate device 325 may comprise a mesh agglomerator. It should be understood that intermediate device 325 is not to be limited to vanes to impart rotation or a mesh, but rather intermediate device 325 may include any other type of structure that improves function of filter-coalescer systems by altering the gas flow between the first stage and second stage, and/or pre-conditioning the droplets for the coalescer.

For the non-limiting embodiment as shown, intermediate device 325 is positioned to intercept flow going between first stage filter 301 and second stage coalescer 302, and namely to impart rotation to the gas flow.

Optionally, mounting ring 332 may be provided that will allow for use with commercially available filter/coalescer systems, such as the Twist Lok™ system, which includes a first stage filter endcap 311 and a second stage endcap 312. Specifically, when utilized with the Twist Lok™ system, mounting ring 332 will be secured between first stage filter endcap 311 and second stage endcap 312.

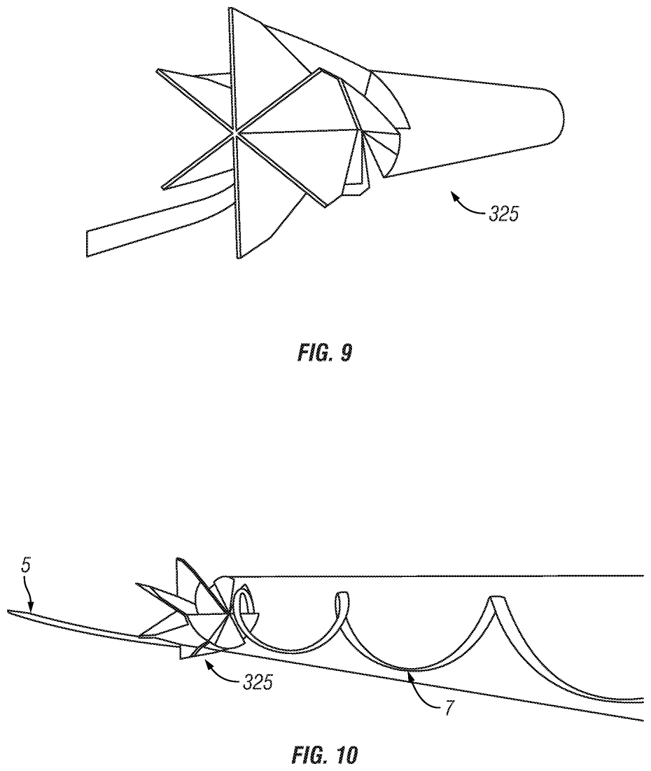

Referring additionally to FIGS. 8-10, there is shown other non-limiting cyclonic embodiments of intermediate element 325. These non-limiting cyclonic embodiments may be axial cyclonic with a center body, can be an angled vane type, or may be a milled slot type.

The filter/coalescer element of the present invention may be utilized with any suitable type of filtration vessel may be utilized in the practice of the present invention, including certain filtration vessels as disclosed in any of U.S. Pat. Nos. 5,919,284, 6,187,647, 7,014,685, 7,108,738, and 9,566,543, and in any of U.S. Pat. Publication Nos. 20100224065 and 20140165516. Depending upon the situation and operating conditions, suitable filtration vessels may include multi-stage vessel 11 as shown in FIG. 1 of U.S. Pat. No. 6,187,647, and filter vessel 13 as shown in FIG. 1 of U.S. Pat. No. 7,014,685, with the understanding that vessels 11 and 13 will include the filtration filter/coalescer element as disclosed herein and be adapted to receive such filter/coalescer element.

Certain embodiments of the present invention provide for customizing the filtration, agglomeration, coalescence and/or separation. With fewer solids, the initial filter can do more coalescing, and with dirtier service, primary filtration can be handled with the front side of the filter and coalescence and separation on the back side of the filter.

Certain embodiments of the present invention to provide for a filter system that provides the ability to shift forward and backward without changing the vessel.

Certain embodiments of the present invention to provide for a vessel that can be used for gas conditioning, and the same setup can be used for liquid/liquid separation as well.

All of the patents, publications, applications, articles, books, magazines, and any other prior art cited in this specification, are herein incorporated by reference.

It should be understood that the methods, apparatus and products of the present invention find utility in a wide range of industries and applications, including but not limited to, agriculture, biotech, biochemicals, beverage processing, chemicals, construction, crude oil environments, food processing, gas processing, hydrocarbon processing, hydrocarbon production, laboratories, manufacturing, medical, mining, petrochemicals, pharmaceuticals, research, water treatment, and in any other industry or application where it is desired filter particulates from gases.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A replaceable cartridge for use in a vessel for processing a flowing gas stream comprising droplets, the cartridge comprising:
a first stage member comprising a filer element;
a second stage member comprising a coalescer element; and
an intermediate stage member interposed between the first and second stages, said intermediate stage comprising structure to alter the flowing gas stream as it flows between the first and second stages and pre-condition the droplets, said structure selected from the group of structures consisting of baffles, spargers, in-line mixers, spiral shaped baffles, wire mesh, vaned members, slotted members, and protrusions.

2. The cartridge of claim 1, wherein the intermediate stage comprises baffles.

3. The cartridge of claim 1, wherein the intermediate stage comprises spiral baffles sufficient to impart rotation to the flowing gas stream.

4. The cartridge of claim 1, wherein the intermediate stage comprises mesh.

5. A method of processing a flowing gas stream comprising droplets, the method comprising:
Filtering the gas stream in a first stage filter element to produce a filtered gas stream;
Altering the filtered gas stream in an intermediate stage to alter the flow pattern of the filtered gas stream and pre-condition the droplets to produce an altered-flow gas stream; and,
Coalescing the altered-flow gas stream in a second stage coalescer to produce processed gas.

6. The method of claim 5, wherein the altering step comprises passing the filtered gas stream past a spiral vane to rotate the filtered gas stream.

7. The method of claim 5, wherein the altering step comprises passing the filtered gas stream through a mesh.

8. An apparatus for separating liquids and solids from a gas stream and simultaneously coalescing liquids from the gas stream, the apparatus comprising:
a closed vessel having a longitudinally extending length, an initially open interior, an input port at an extent and an output port at an opposite extent thereof;
a partition located within the vessel interior, the partition dividing the vessel interior into a first stage and a second stage;
at least one opening in the partition;
a separator/coalescer filter element disposed within the vessel to sealingly extend from within the first stage through the opening into the second stage, with the filter element defining a hollow core and comprising an intermediate device positioned within the hollow core and comprising structure selected from the group of structures consisting of baffles, spargers, in-line mixers, spiral shaped baffles, wire mesh, vaned members, slotted members, and protrusions;
wherein, the input port, vessel interior, separator/coalescer filter element and output port together defining a flow passage within the apparatus, whereby the gas stream flows into the first stage through the input port and through the filter element hollow core thereby filtering solids out of the gas stream, separating liquids from the gas stream, and pre-coalescing liquids in the gas stream, and wherein the gas stream then flows through the intermediate device altering the flow pattern of the gas stream and pre-conditioning the liquids, and wherein the gas stream then flows along the hollow core past the partition and back through the filter element into the second stage, thereby coalescing liquids out of the gas stream, the gas stream then exiting the second stage through the outlet port.

9. The apparatus of claim 8, wherein the intermediate stage comprises baffles.

10. The apparatus of claim 8, wherein the intermediate stage comprises spiral baffles sufficient to impart rotation to the flowing gas stream.

11. The apparatus of claim 8, wherein the intermediate stage comprises mesh.
